(19) United States
(12) Patent Application Publication
(10) Pub. No.: US 2024/0012843 A1
(43) Pub. Date: Jan. 11, 2024

(54) METHOD FOR GENERATING A GRAPHICAL SUMMARY, A COMPUTER PROGRAM AND A SYSTEM

(71) Applicant: VAVISUAL ABSTRACT GMBH, Mannheim (DE)

(72) Inventors: Benito CAMPOS, Heidelberg (DE); Saribek KARAPETYAN, Stuttgart (DE); Gaurav SINHA, München (DE)

(21) Appl. No.: 18/245,241

(22) PCT Filed: Sep. 6, 2021
(86) PCT No.: PCT/EP2021/074479

§ 371 Date: Mar. 14, 2023

(30) Foreign Application Priority Data
Sep. 16, 2020 (DE) 10 2020 124 144.5

(51) Int. Cl. G06F 16/34; G06F 16/51; G06F 40/40; G06F 40/186; G06T 11/60

(52) U.S. Cl. CPC G06F 16/345; G06F 16/51; G06F 40/40; G06F 40/186; G06T 11/60

(57) ABSTRACT

A method for generating a graphical summary from at least one text by means of a computer comprising the following steps performed by the computer:
a) loading the text as an electronic text file,
b) identifying predefined words in the loaded text,
   c) assigning a prepared graphic to each one or a plurality of predefined words in the text,
d) storing the assignment from step c) in an electronic list,
e) generating an electronic image file from the graphics according to the assignments stored in the electronic list, the graphics being arranged in the electronic image file in the form of a collage,
f) outputting the electronic image file as the graphical summary of the text to be generated.

The invention relates to a method for generating a graphical summary from at least one text by means of a computer according to the characteristics of claim 1. The invention also relates to a computer program for conducting such a method as well as a system with at least one computer and at least one memory in which such a computer program is stored.

Scientific articles are regularly published that include an abstract which makes it easier for researchers to search for and find relevant articles. Nevertheless, in practice it is still the case that sifting through a large number of scientific articles or abstracts is a very laborious exercise, particularly because reading numerous abstracts requires considerable effort and at some point one's concentration begins to wane. To produce an abstract is also extremely time-consuming, especially for highly complex scientific articles that are to be condensed into the form of a short and succinct extract.

The invention is based on the task of providing an automated solution with which the above-named problems are at least reduced.

In accordance with claim 1, this task is solved by way of a method for generating a graphical summary from at least one text by means of a computer, comprising the following steps performed by the computer:
a) loading the text as an electronic text file,
b) identifying predefined words in the loaded text,
c) assigning a prepared graphic to each one or a plurality of predefined words in the text,
d) storing the assignment from step c) in an electronic list,
e) generating an electronic image file from the graphics according to the assignments stored in the electronic list, the graphics being arranged in the electronic image file in the form of a collage,
f) outputting the electronic image file as the graphical summary of the text to be generated.

As a result, the assignment of the particular prepared graphic determined in step c) to one or multiple predefined words identified in the text can be stored in step d), e.g. as a reference to the graphic. Alternatively, the graphic itself can also be stored in the electronic list.

The graphics for which an assignment is stored in the electronic list are thus used to generate the electronic image file. The graphics can be taken from a general database, for example, or from an electronic list if they are stored there.

A summary is thus automatically created from the originally available text or text file using a computer-implemented method. The summary contains graphical elements, which is why it can be described as a graphical summary. In addition, it is particularly preferable if the graphical elements are stored in the form of a collage, i.e. they can be arranged on top of and/or next to each other on a two-dimensional image, both in alignment with each other as well as in an offset arrangement.

As can be seen, the focus of the present invention is not on conveying certain content or conveying it in a particular layout, but the presentation of image content in a way that takes the physical factors of human perception and reception of information into account. The invention aims to enable humans to perceive the displayed information in a particular way in the first place, or at least to improve it and make it more useful.

Since graphics are processed by the human brain more quickly than text, this accelerates perception. Furthermore, condensing the volume of text means that the content can be absorbed with less effort regarding reading, thereby enabling an acceleration in the reception of information. In addition, combining graphics with text and thus taking into account human reception of information means that the information received is more effectively anchored in the memory. Research shows that the capacity for visually processing images is a matter of milliseconds. It has been observed that test subjects are able to correctly interpret unknown images within 150 ms. The mean reading speed, on the other hand, is 202 words per minute for young, normally sighted subjects in English and with standardized reading charts (Radner reading charts) and decreases with the difficulty of the text.

A theoretical explanation for the positive effects of visualizations is provided by the cognitive theory of multimedia learning using text and images. The learning process is facilitated when learners establish referential connections between their separately developed mental representations of verbal and visual material and their previous knowledge,

Each of the prepared graphics used may be designed as an electronic image file.

The identification of predefined words in the loaded text can occur, for example, by means of a simple text comparison and/or using complex algorithms, e.g. automatically taking grammar rules, fuzzy logic and/or neural networks into account. When predefined words are identified in the text, they may appear in the text in the form of individual words, for example, or as parts of compound words. In both cases, they can be automatically identified.

The invention can be utilized to improve the reception of texts and the process of learning in all areas, i.e. for all kinds of texts.

An especially beneficial field of application of the invention is the field of scientific texts. The invention can be used to enable the automatic generation of graphical summaries for scientific texts. The invention offers another benefit in this field, namely that the computer-implemented solution renders it possible to generate standardized graphical summaries, meaning that they do not depend on the style of the individual author.

A scientific text is a systematically organized text in which one or multiple scientists present the findings of their own research. Scientific texts generally emerge at universities or other research institutes, including private ones, and are composed by students, PhD students, professors or other researchers. A scientific text is based on previous scientific work, which is presented in the scientific text.

Scientific work describes a methodical, systematic procedure in which the results of the work are objectively comprehensible or repeatable for everyone. This means that sources are provided (cited) and experiments described in such a way that they can be reproduced. Based on the facts and evidence that the author has used to draw their conclusions, those who read a scientific paper can always identify which research findings of other scientists the author has referred to (citation) and which (new) aspects come from the author themselves.

The text loaded as an input variable may be the full scientific text or a part thereof, for example a previously prepared abstract. The text loaded as an input variable can also be another text, for example text components of a patent document, a technical standard or other technical description, such as the operating instructions for a device.

According to an advantageous embodiment of the invention, it is provided for that the predefined words are contained in a predefined list, the list being stored in an electronic database, wherein a prepared graphic is assigned in each case to one or multiple words in the database. The graphical summary can thus be generated in a defined, standardized manner. The use of such a database has the additional advantage that it can be accessed from various locations, so that graphical summaries can be created at different locations according to the same standards.

The assignment of the prepared graphic to one or multiple words can be an unambiguous assignment or an ambiguous assignment, for example a diffuse assignment according to the principle of fuzzy logic or the principle of neural networks.

According to an advantageous embodiment of the invention, it is provided for that an output file is generated and output by the computer that contains the graphical summary and metadata in text form. As such, the output file not only contains graphical data, but also metadata in text form. This has the advantage that the generated output files can in turn be automatically captured and evaluated, for example by search engines. The output file can then even be found by way of a simple text search for key words. The metadata can be composed, for example, of the predefined words linked with the graphic or at least a part thereof.

According to an advantageous embodiment of the invention, it is provided for that one or multiple metadata, which describe the image content of the graphic, are assigned in each case by the computer to a graphic in the graphical summary. This has the advantage that, for example, search engines do not have to conduct an initial analysis of the graphic and assignment of a matching term; rather, they can directly access the metadata that describe the image content of the graphic.

According to an advantageous embodiment of the invention, it is provided for that characteristic words in the text can be identified by the computer and, using the characteristic words identified, a short summary of the text is generated in text form, wherein an output file is generated and output by the computer in which the graphical summary is combined with the short summary. As a result, the amount of information in the output file can be significantly increased without overwhelming the viewer. The content of the output file can still be comprehended relatively quickly and it is not as tiring for the viewer as understanding the entire text.

In this case, the short summary of the text can be combined in a graphical manner with the graphical summary. Different parts of the short summary can also be arranged in a distributed manner and intermixed with the graphics. The output file can be a pure image file. In this case, the short summary can be converted into an electronic image format. The output file may also be a combination of the graphics (in the form of image files) and text components of the short summary, for example in the style of HTML documents.

According to an advantageous embodiment of the invention, it is provided for that the layout of the graphical summary always features the same structure, regardless of the content of the text. This has the advantage that, due to the uniform design, perception is accelerated when viewing a sequence of multiple graphical summaries as opposed to pure text abstracts. The capacity to visually process images can be increased approximately 10-fold to 13 ms under consistent conditions. This capacity to identify images that have been viewed for such a short amount of time can help the brain when it is deciding where to focus the eyes, which jump from point to point some three times per second in short movements known as fixations. The decision of where to move the eyes can take 100 to 140 milliseconds, so that very quick comprehension must occur beforehand.

According to an advantageous embodiment of the invention, it is provided for that the graphics are added to the graphical summary in at least two different colors. More than two different colors can also be used to differentiate between the graphics. For example, as many colors as graphics can be used, so that each graphic is displayed in a different color.

Colors bind the attention of a viewer differently and at the same time create a sense of being closer or further away. It is thus possible to guide the viewer's attention: From the main statement, to the core content and to the particulars. By taking into account the physical factors of human perception, this perception is successfully accelerated.

The physiological explanation for this phenomenon is that, due to the characteristics of the human eye, violet-blue images appear to be further away than red-light images, which appear closer to the viewer. A typical healthy eye receives blue-green light (images) directly on the fovea, whereas violet-blue light is focussed slightly in front of the fovea. When attempting to focus these images, the lens of the eye becomes slightly less convex, so that the violet-blue image(s) appear to be slightly further away. Red light (images), on the other hand, focusses just behind the fovea. The lens becomes slightly more convex, so that the red images appear to be slightly closer to the viewer.

According to an advantageous embodiment of the invention, it is provided for that the graphical summary or the output file is transmitted via a global network, in particular the internet, to a correction entity; after being edited by the correction entity, a corrected graphical summary or output file is received. The correction entity can be a system that works automatically. The correction entity may also comprise manual post-processing. This further increases the quality of the generated graphical summaries.

According to an advantageous embodiment of the invention, it is provided for that
g) the computer electronically forwards the image file generated in step e) of the method along with the text used to generate this image file to proofreaders, the proofreaders being at least one predefined person,
h) at least one proofreader then compares the text with the graphic assigned in step c) of the method and
i) at least one proofreader enters at least one correction result into an electronic database, the correction result containing the following electronic database entry,
j) a list of the graphics listed in step d) of the method that are contained in the image file generated in step e) of the method and that were incorrectly assigned to the text used in step c) of the method to generate this image file,
k) an automatic database entry is then generated after the database entry has occurred, said automatic database entry showing a database administrator which graphics were incorrectly assigned,
l) a database administrator then checks the database entry generated in step j) of the method,
m) and deletes one or multiple incorrectly assigned graphics from the image file generated in step e) of the method and replaces each incorrectly assigned graphic with a correct graphic.

This makes it possible to check the accuracy of the content of an automatically generated graphical abstract by way of a partially automated method.

The task named at the beginning is also solved by a computer program with program coding means that is configured to carry out a method of the type described above when the computer program is run on a computer. This also achieves the advantages explained above.

The task named at the beginning is also solved by a system with at least one computer and at least one memory in which a computer program of the type described above is stored, the computer having access to the memory and being configured to run the computer program. This also achieves the advantages explained above.

In summary, it can be said that the advantages achieved with the invention are, in particular, that graphical abstracts can be generated automatically using a cost-effective, fast and standardized method. The graphical abstracts generated can be linked with the text abstract, which makes it possible to search for them with common search engines.

As described above, an important aspect of the invention is the acceleration of perception experienced by a reader when registering the standardized graphical summaries (visual abstracts). There are now well-founded research data available on this point. The efficacy of the standardized visual abstract was examined in a pilot study. In this pilot study, the reading speed and memorization of content exhibited by a representative cohort of medical researchers were measured. 10 people working in cancer research and three other medical disciplines were examined. At the time of the study, they were working in four different countries. Among them were people just starting out in research, experienced researchers as well as professors. In a randomized cross-over study, the average reading speed for text abstracts and corresponding visual abstracts was examined as well as the amount of content memorized (tested via multiple choice questions). In the post-hoc analysis, the pilot study showed sufficient power (85%) in terms of the primary endpoint (reading speed). The reading speed was 2.6 times faster for visual abstracts (p<0.001) than for pure text extracts. There was no significant difference in the memorization of content (p=0.59).

The layout comprised three panels in three different colors: Red, yellow and blue. As previously mentioned, colors bind the attention of a viewer differently and at the same time create a sense of being closer or further away. It is thus possible to guide the viewer's attention: From the main statement (red), to the core content (yellow) and to the particulars (blue). At the same time, the selection of the panel colors was optimized by transparency and pastel colors in order to direct a viewer's attention to the text and image content of the respective panel. Necessary text elements, such as study citations and footnotes, were placed in discrete shades of gray outside of the actual visual abstract so as not to distract the viewer's attention from the three panels. It was particularly relevant that, in 80% of the cases and already on the first read, the eye movement of the participants in the study went intuitively and correctly from the main statement (red), to the core content (yellow), to the particulars (blue), which in turn proves that eye movement does not occur randomly between the panels; rather, by taking into account the physical factors of human perception, targeted eye movement and therefore an acceleration of perception occurs.

There are other beneficial uses for the metadata generated during text mining, e.g., adoption as keywords in literature databases. Furthermore, the visual abstracts outlined here can be searched for in a more targeted manner using the associated metadata, which makes it easier for researchers to find relevant research publications. Current search engines depend on keywords, which are largely determined by researchers themselves. Medical journals regularly call for publications to be provided with more specific and better selected keywords to enable a more precise search for research publications. However, researchers see the provision of keywords as an onerous task to which only minimal time is dedicated. The high-quality metadata mentioned at the beginning are created independently of researchers and through the semantic treatment of medical or other abstracts. They enable a precision when searching for publications that cannot be achieved with common search engines. For example, a literature search using PubMed looking for clinical trials with 50-100 study participants, a double-blind trial design, and quality of life as the primary study endpoint yields not only tens of thousands of search results, but also a large proportion of non-specific results, so that researchers must spend hours scrutinizing the abstracts of the search results. The innovation described here, on the other hand, can extract variables such as study type, number of participants, type of blinding or primary study endpoint and store them as metadata, so that the same search conducted previously in PubMed delivers, thanks to the metadata, search results with almost 100% sensitivity and specificity.

In the following, the invention will be explained in more detail with the aid of embodiment examples accompanied by drawings. The drawings show:

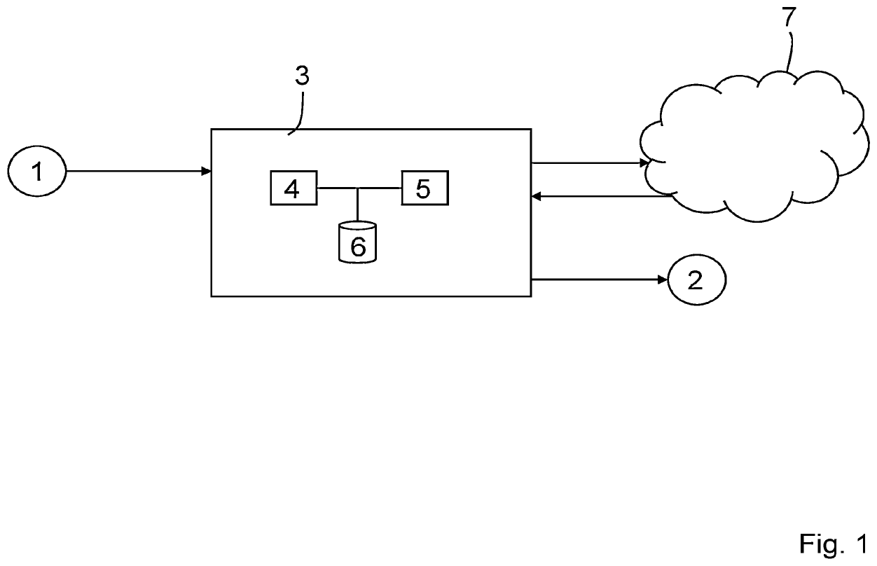

FIG. 1 a schematic representation of a system for conducting the method;

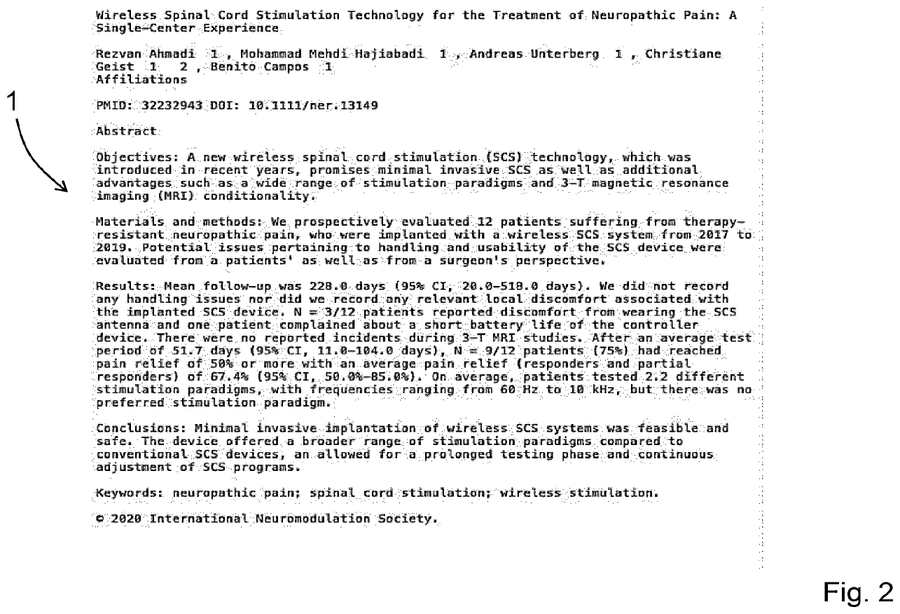

FIG. 2 a scientific text;

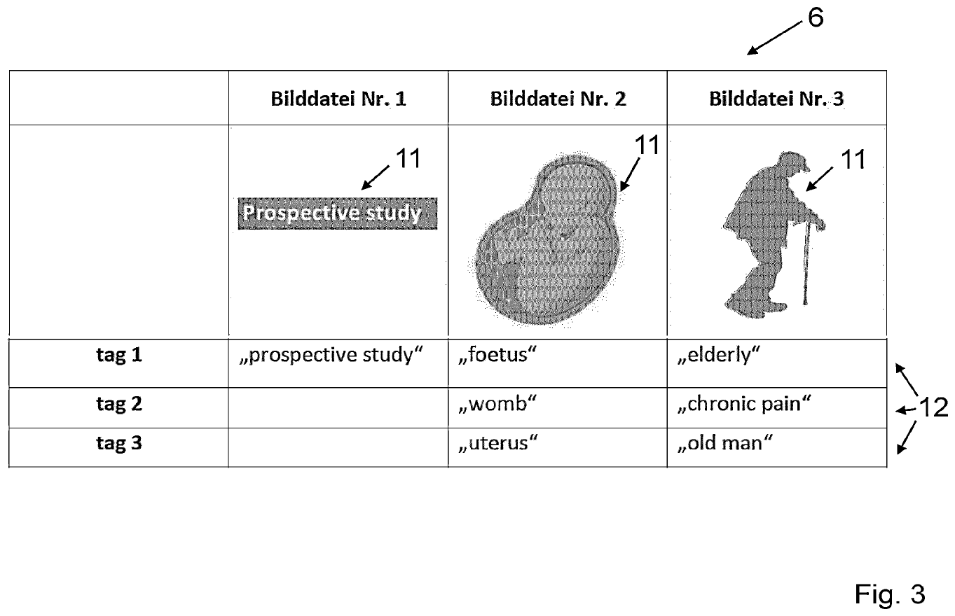

FIG. 3 the content of an electronic database;

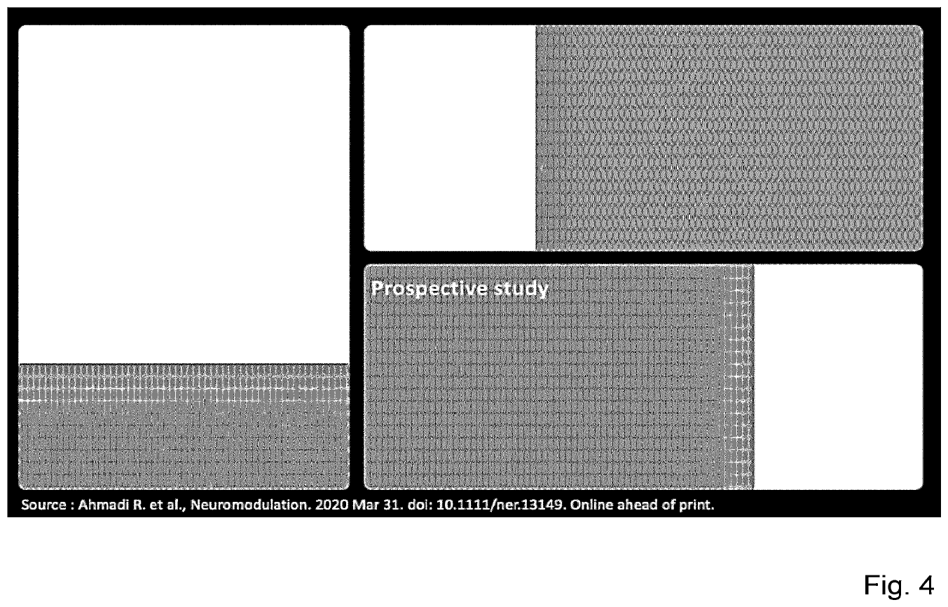

FIG. 4 a basic template for the electronic image file to be created;

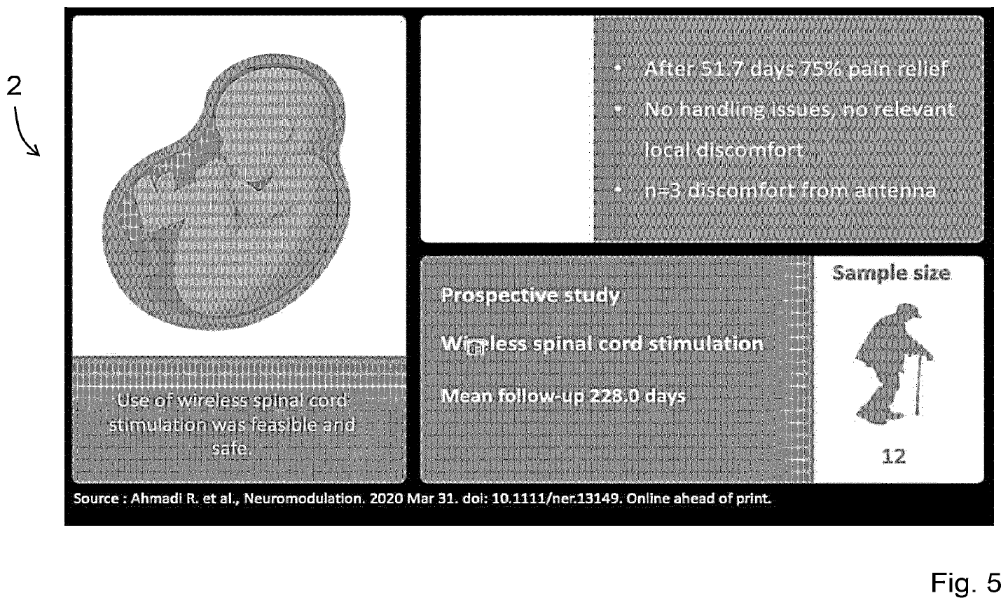

FIG. 5 a generated output file with electronic image file;

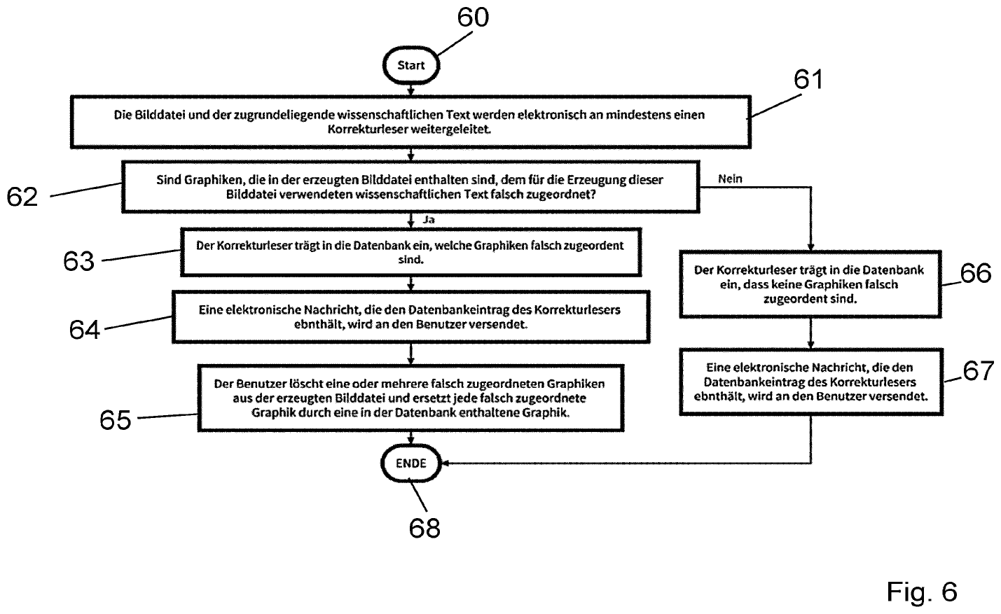

FIG. 6 a flow diagram for a correction procedure;

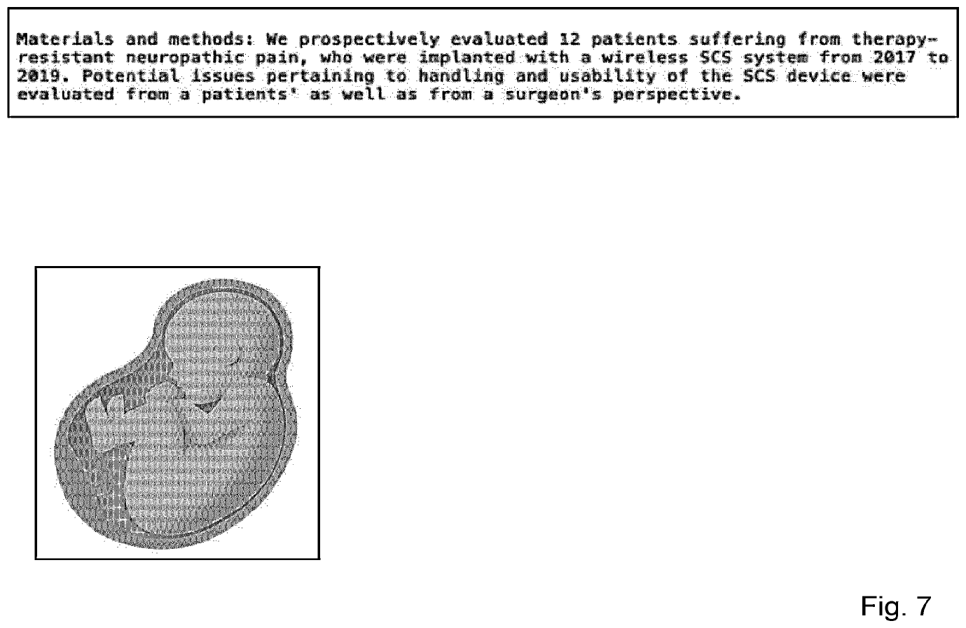

FIG. 7 components of the electronic image file to be corrected;

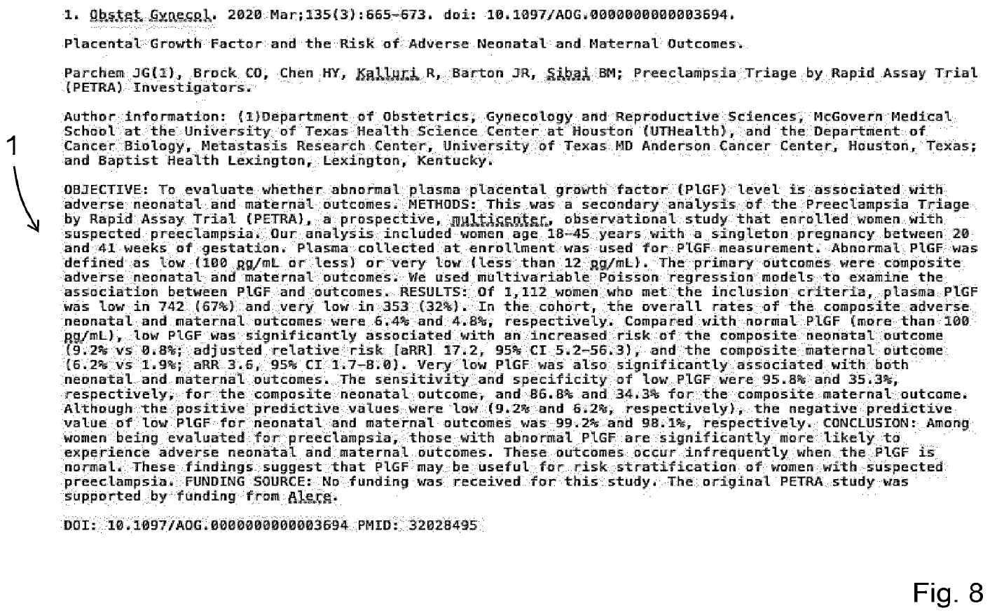

FIG. 8 a further scientific text;

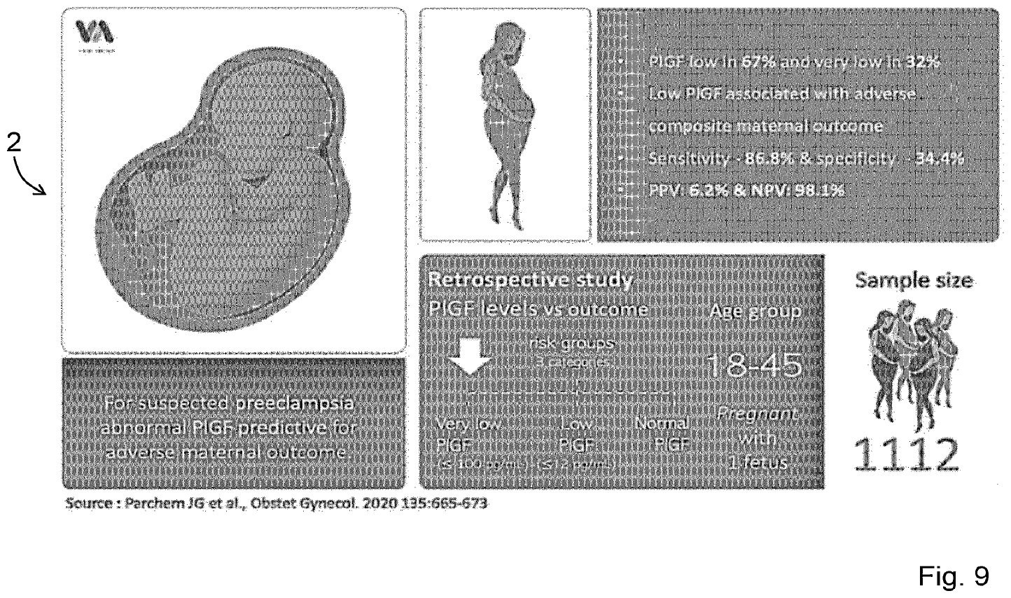

FIG. 9 a further output file;

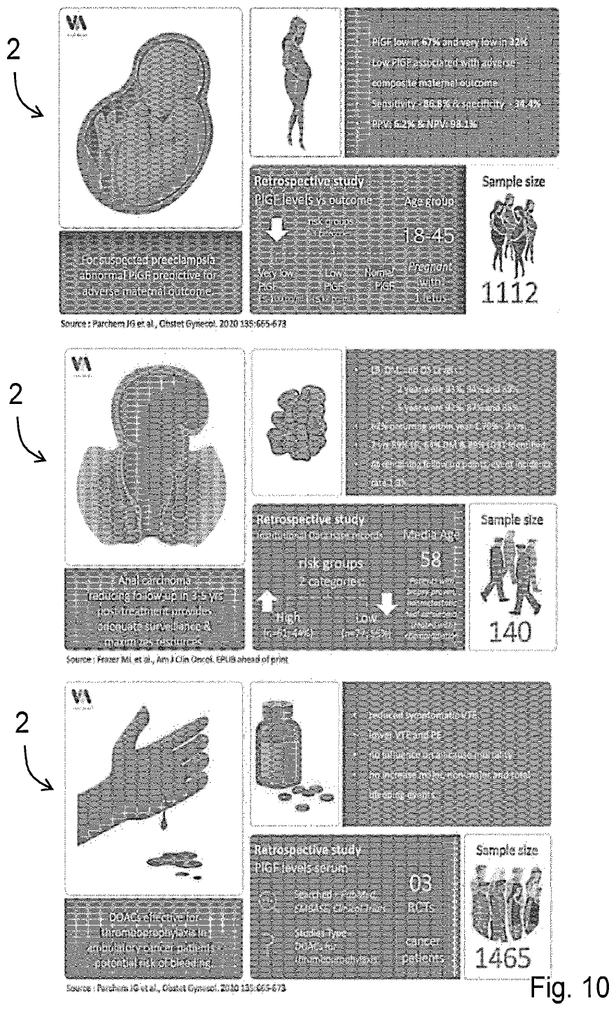

FIG. 10 a comparison of multiple output files;

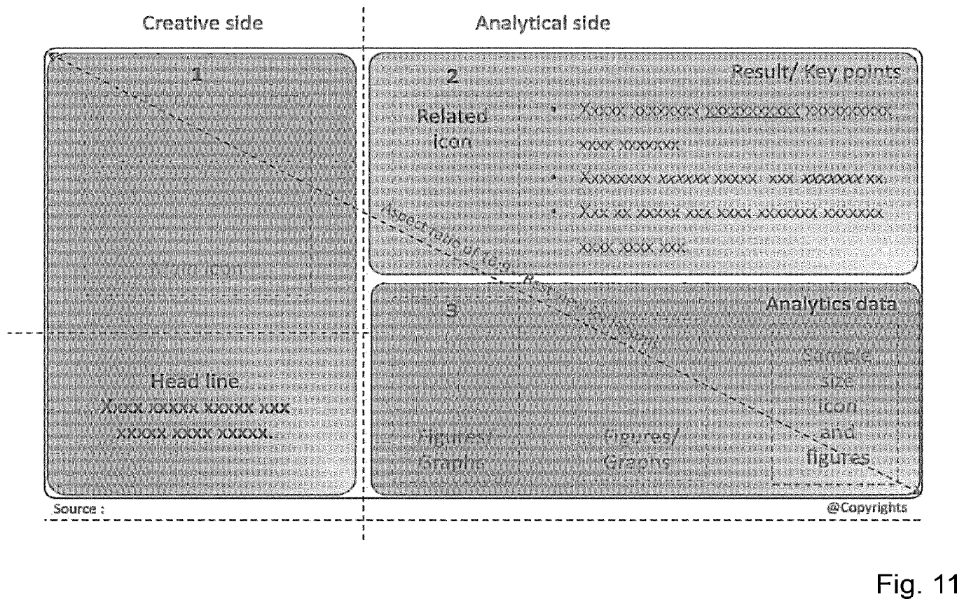

FIG. 11 completion guidelines for the basic template.

FIG. 1 depicts a system 3 with which the method according to the invention can be conducted. The system 3 comprises a computer 4, a memory 5 and a database 6. The computer 4 has access to the memory 5 and the database 6. A computer program is stored in the memory 5 by way of which the method according to the invention is carried out when it is run on the computer 4. The database 6 contains a predefined list of the predefined words 12 to be identified by the method. In each case, a prepared graphic 11 is assigned to one or multiple words 12 in the database 6, as explained in FIG. 3.

A text 1 in the form of an electronic text file is fed into the system 3 as an input variable. The system 3 generates an output variable in the form of a graphical summary of the text or an output file 2 enhanced with additional data. A correctional step can be performed prior to the final output of the output file 2. Here, the graphical summary or output 2 so far generated by the system 3 is transmitted via a global network 7 to a correctional entity. Following editing by the correctional entity, a corrected graphical summary or output file is received and either immediately output or further processed in the system 3.

FIG. 2 shows a scientific text 1 in the form of an abstract, the scientific text 1 being an electronic text file. The text file is loaded in step a) of the method. The method is able to identify predefined words in the scientific text 1.

When doing so, the method follows predetermined rules. In this embodiment example, the type of study described in text 1 is determined from the scientific text 1. In this step of the method, the method applies, for example, a previously established rule:
1. Search for the words “secondary analysis” AND/OR “retrospective” AND/OR “records review” AND/OR “cost-effectiveness analysis”
2. Save the search result in the variable “retrospective_studytype”
3. Search for the words “prospective” AND/OR “trial”
4. Save the search result in the variable “prospective_studytype”
5. Search for the words “systematic review” AND/OR “meta-analysis” AND/OR “literature search”
6. Save the search result in the variable “metaanalysis_studytype”
7. IF (the variable prospective_studytype contains more than 0 hits AND the variable retrospective_studytype contains 0 hits AND the variable metaanalysis_studytype contains 0 hits THEN save “studytype: prospective study”) OTHERWISE (IF the variable retrospective_studytype contains more than 0 hits AND the variable prospective_studytype contains 0 hits THEN save “studytype: retrospective study”)
8. IF (the variable metaanalysis_studytype contains more than 0 hits THEN save “studytype: meta-analysis/systematic review/treatment guidelines”) OTHERWISE save nothing.

By applying the above-named rule to the scientific text 1, the method is able to correctly identify the type of study as a prospective study and to save the study type in an electronic database under the relevant variable as “prospective study”.

The method now applies further rules one after the other in order to e.g. identify the type of illness described in text 1, to determine the number of subjects examined and to recognize the nature of the study target variables under examination. It is advantageous to complement the rule application process depicted in this step of the method with “machine learning” processes.

In a further step, prepared graphics 11 are assigned to the search results stored in the various variables, wherein more than one prepared graphic 11 is saved in the electronic database 6.

FIG. 3 shows an example of the content of the database 6. In this embodiment example, there are three prepared graphics 11 in the electronic database 6, the prepared graphics 11 being electronic image files that are stored in the electronic database 6. It refers to an image file with the words “Prospective study” (image file no. 1), the image of a fetus (image file no. 2) and the image of a man with a walking stick (image file no. 3). Each of these three image files is linked to so-called “tags”, a “tag” being at least one word that is stored in the electronic database 6, wherein at least one “tag” is linked to at least one prepared graphic 6. In this embodiment example, the “tags” define the predefined words 12 to be identified by the method in the loaded text 1 and the graphics 11 linked to them.

In this embodiment example, the study type was identified as a prospective study and saved in the variable “studytype” as “prospective study”. The content of the variable is now compared with the “tags” of all prepared graphics 11 stored in the electronic database 6. Since there is a full match between the content of the variable and tag 1 of image file no. 1, the method saves this link. The step is then repeated for all further variables until the content of all saved variables has been compared with all “tags” of the prepared graphics 11, each full match between the content of a variable and the tag of an image file being stored as a link.

An electronic list of all graphics 11 that are linked with the stored variables is subsequently created by matching “tags” in order to then, in step 1e of the method, generate an electronic image file from the graphics 11 specified in the electronic list, the electronic image file containing a collage of the graphics 11 contained in the electronic list.

FIG. 4 depicts a basic template for the electronic image file to be created. This basic template corresponds to an empty “collage wall”, wherein image files are added at predefined points of the basic template. In this embodiment example, image file no. 1 (image file with the words “Prospective study”) is already placed in the lower right-hand third of the image.

As mentioned, an electronic image file or output file 2 is generated from the graphics 11 contained in the electronic list, which is shown as an example in FIG. 5. In this embodiment example, the study type was identified as a prospective study and linked to image file no. 1 (image file with the words “Prospective study”) via the steps of the method. Image no. 1 is now copied into the basic template. This step is conducted with all graphics 11 contained in the electronic list until all image files have been integrated into the “collage wall”. In this embodiment example, the method results in the electronic output file 2 rendered in FIG. 5.

As can be recognized in this embodiment example, the image of a fetus has been placed in the upper left-hand part of the image. As no fetuses are mentioned in the underlying text 1, this is an incorrect assignment. Incorrect assignments can be automatically or partially automatically identified and corrected.

FIG. 6 shows a flow diagram of a correction process for identifying and correcting incorrect assignments. The process begins with a step 60. In a subsequent step 61, at least parts of the generated electronic image file and the underlying text 1 are automatically forwarded to proofreaders. In the following step 62, at least one proofreader checks the accuracy of the content of the parts of the image file with the aid of the underlying scientific text 1. The result of the check can be saved by the proofreader as a database entry. If an incorrect assignment is identified, the proofreader enters the incorrectly assigned graphics into the database in step 63. Otherwise, the process is continued with step 66, in which the proofreader enters in the database that no graphics are assigned. An automatic database entry can then be generated that shows a database administrator if and, if so, which graphics have been incorrectly assigned (steps 64, 67). The database administrator can than delete incorrectly assigned graphics from the image file generated in the method and replace each incorrectly assigned graphic with a correctly assigned graphic contained in the database 6 (step 65). The process ends with step 68.

In this embodiment example, the system 3 would send e.g. the image section shown below in FIG. 7 as well as the text abstract section shown above, which was used in steps 1b and 1c of the method to establish the assignment between image file (here, an image file of a fetus) and the “collage wall”, to at least one proofreader. The proofreader answers the following (subjective) question: “Has the graphic been correctly assigned to the text?”. The proofreader has the choice between “Yes”, “Maybe” and “No” as an answer. The answer is saved by the proofreader as a database entry, wherein an automatic database entry is generated that shows a database administrator if and, if so, which graphics have been incorrectly assigned, and the database administrator subsequently checks incorrectly assigned graphics (proofreader responds with “No”) and/or potentially incorrectly assigned graphics (proofreader responds with “Maybe”) and, in the event of an incorrect assignment, deletes them from the generated image file and replaces each incorrectly assigned graphic with a correctly assigned graphic 11 contained in the database 6. The correction process depicted in this step of the method can be supported by crowd-sourcing, for example, via the service provider Amazon mechanical Turk, and fully automated according to the process described here.

FIG. 8 depicts a further example for a text 1, which serves as a basis for the example of an output file 2 generated by the method according to the invention, shown according to FIG. 9. This example should illustrate that a relatively extensive base text 1 is significantly reduced in the output file 2 by the method according to the invention and is thus much quicker to comprehend. The text 1 has 348 words, whereas the output file 2 only has 83 words and 3 images. The reading effort and time required to comprehend the content is much lower due to the replacement of text with images and the condensation of the volume of text.

With the aid of the three output files 2 represented, FIG. 10 illustrates the advantages of always having the same layout of the output file 2 or the generated graphical summary. For example, the layout may always feature three panels, the panels always being the same colors, the proportions of the panels remaining constant, and the image exhibiting a length-to-height ratio of 16:9. Due to the uniform design, an acceleration of perception can be achieved in the sequential viewing of multiple graphical summaries.

FIG. 11 depicts the base template as well as the completion guidelines for the base template. The first panel on the left-hand side is kept in shades of red and contains the main message of the text 1; the upper right-hand panel in shades of yellow contains the core content, e.g. a key-point summary of the text 1; and the bottom right-hand panel in shades of blue contains particulars, e.g. the statistical and numerical facts in text 1.

1. A method for generating a graphical summary from at least one text by a computer comprising the following steps performed by the computer:
a) loading the at least one text as an electronic text file,
b) identifying predefined words in the electronic text file loaded in step a),
c) assigning a prepared graphic of a plurality of graphics to each one or a plurality of predefined words identified in the at least one text in step b,
d) storing oner or more assignments from step c) in an electronic list,
e) generating an electronic image file from one or more graphics of the plurality of graphics according to the one or more assignments stored in the electronic list, the one or more graphics being arranged in the electronic image file as a collage,
f) outputting the electronic image file as a graphical summary of the at least one text.

2. The method according to claim 1, wherein the at least one text is a scientific text, and the predefined words at least partially contains specialist scientific terms.

3. The method according to claim 1 wherein the predefined words are contained in a predefined list stored in an electronic database, wherein the prepared graphic is assigned in each case to one or multiple words in the database.

4. The method according to claim 1 further comprising generating and outputting by the computer an output file that contains the graphical summary and metadata in text form.

5. The method according to claim 4, wherein one or multiple metadata which describe image content of the one or more graphics are assigned in each case by the computer to each a graphic in the graphical summary.

6. The method according to claim 1 further comprising identifying one or more characteristic words in the at least one text and, using the one or more characteristic words identified, generating a short summary of the at least one text in text form, and generating and outputting an output file by the computer in which the graphical summary is combined with the short summary.

7. The method according to claim 1 wherein a layout of the graphical summary always features a same structure, regardless of content of the at least one text.

8. The method according to claim 1 wherein the one or more graphics are added to the graphical summary in at least two different colors.

9. The method according to claim 4 wherein the graphical summary or the output file is transmitted via a global network to a correction entity which edits the graphical summary or the output file, and receiving a corrected graphical summary or output file after editing by the correction entity.

10. A computer program on a non-transient computer readable medium comprising coding configured to carry out the method according to claim 1 when the computer program is run on a computer.

11. A system, comprising at least one computer and at least one memory in which a computer program according to claim 10 is stored, the computer having access to the memory and being configured to run the computer program.
